(19) United States
(12) Patent Application Publication
(10) Pub. No.: US 2024/0289135 A1
(43) Pub. Date: Aug. 29, 2024

(54) BASIC INPUT/OUTPUT SYSTEM SETTING INFORMATION PRESENTATIONS

(71) Applicant: Hewlett-Packard Development Company, L.P., Spring, TX (US)

(72) Inventors: Yan-Heng Chen, Taipei City (TW); Hung Lung Chen, Taipei City (TW); Tsue-Yi Huang, Taipei City (TW)

(73) Assignee: Hewlett-Packard Development Company, L.P., Spring, TX (US)

(21) Appl. No.: 18/173,515

(22) Filed: Feb. 23, 2023

(51) Int. Cl. G06F 9/4401; G06F 1/26

(52) U.S. Cl. CPC G06F 9/4403; G06F 1/26

(57) ABSTRACT

In an example, in response to detecting a connection with a host computing made with a data and/or power delivery cable, a display device can present BIOS settings obtained from the host computing device via an on-screen display (OSD) of the display device and transmit inputs to the BIOS settings made via the OSD to the host computing device via the connection. Once received, the host computing device can store the inputs to the BIOS settings in a memory shared with an embedded controller (EC) of the host computing device. The EC can affect certain BIOS settings from the shared memory until the BIOS accesses the BIOS setting inputs from the shared memory and formally implement them during a subsequent, later reboot.

### BACKGROUND

Generally described, computing devices can be configured with settings implemented upon powering on the device. These settings can be stored in a basic input/output system (BIOS). In a common application, BIOS settings can be changed from a BIOS menu after the device has been powered on and is booting. However, once booted, if a BIOS setting is changed, it cannot be implemented until the device is rebooted. Accordingly, the computing device must be immediately rebooted each time a BIOS setting is changed.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1A is a pictorial diagram depicting an example system in which a host computing device is connected to a display device that may be used to input settings of a basic input/output system (BIOS) of the host computing device without requiring immediate reboot of the host computing device;

FIG. 1B is a pictorial diagram of an example menu including the BIOS settings of the host computing device as presented on the display device in FIG. 1A;

FIG. 2 is a block diagram of example components of the host computing device and the display device that enable inputs to the host computing device's BIOS settings to be affected without requiring immediate reboot of the host computing device;

FIG. 3 is a block diagram depicting example interactions between the components of the host computing device and the display device when the host computing device communicates BIOS settings to the display device for presentation;

FIG. 4 is a block diagram depicting example interactions between the components of the display device and the host computing device when an input changing a BIOS setting of the host computing device is made at the display device;

FIG. 5 is a flow diagram depicting an example routine implemented by the display device for providing an input to a BIOS setting made at the display device to the host computing device in accordance with aspects of the present disclosure;

FIG. 6 is a flow diagram depicting an example routine implemented by the host computing device for updating its BIOS with the input to the BIOS setting made at the display device in accordance with aspects of the present disclosure;

FIG. 7 is a block diagram of an example architecture for a display device that provides, to the host computing device, the input to a BIOS setting made at the display device; and

FIG. 8 is a block diagram of an example architecture of a host computing device that updates its BIOS with the input to a BIOS setting made at the display device.

### DETAILED DESCRIPTION

Generally described, a host computing device, such as a laptop, notebook, desktop computing device, or any other computing device capable of communicating with a display device., may include a BIOS that initializes and tests the hardware of the host computing device and loads the operating system of the computing device after the host computing device powers on. This process may be referred to as the boot process, or “booting” or “boot up.” This process may be repeated when the host computing device is restarted, in which case the process may be referred to as a “reboot.” Settings for the BIOS provide the initial operating instructions for the host computing device. For example, BIOS settings may specify a boot order controlled by the bootstrap loader, Complementary Metal-Oxide Semiconductor (CMOS) settings, and BIOS drivers. CMOS settings control the low-level settings of the host computing device including system passwords or BIOS passwords for the host computing device. BIOS drivers include basic operational controls for the host computing device and may, for example, identify which ports or built-in peripherals are enabled in the host computing device. Conventionally, to change the BIOS settings for the host computing device, a user must access the BIOS settings via a menu during the boot process, e.g., by quickly activating a physical hotkey or switch to display the menu before a power on self-test (POST) initiated by the BIOS is completed. Further, attempts to access the BIOS using conventional methods can be difficult because of the speed of the boot up process of a host computing device. Successfully accessing the BIOS of the host computing device may require several attempts to select the hotkey within the time that will allow access to the BIOS settings. Alternative conventions for accessing the BIOS settings can include using the operating system after the boot process has been completed and the operating system loaded. In either scenario, the host computing device must reboot immediately for the input to the BIOS settings to take effect. Accordingly, in conventional systems, multiple reboots are inevitable when a user wishes to change the BIOS settings and can increase time spent configuring the settings of the host computing device and loading the operating system. Moreover, multiple reboots can increase the risk of a corrupted boot.

In accordance with the present disclosure, it is recognized that when a display device communicates with a host computing device via a connection made with a USB-C cable, an HDMI cable, a DisplayPort cable, or a Digital Visual Interface (DVI) cable (or an adapter for any of the foregoing); or an internal connection made with a low-voltage differential signally (LVDS) connector or an embedded DisplayPort (eDP) connector, the host computing device can leverage the connection and certain components of the display device to input settings for the host computing device's BIOS without requiring as many reboots to the host computing device. More specifically, the display device can present BIOS information, such as BIOS settings, obtained from the host computing device via an on-screen display (OSD) with which the display device is already equipped and transmit inputs to the BIOS settings made via the OSD to the host computing device via the connection. Once received, the host computing device can store the inputs to the BIOS settings in a memory of an embedded controller (EC) of the host computing device that is shared with the BIOS so that both the EC and the BIOS can access the BIOS settings. Accordingly, for those BIOS settings that do not require the host computing device to be rebooted in order to be implemented, the EC can implement or otherwise affect those BIOS settings from the shared memory after they are stored and prior to the next reboot of the host computing device. The BIOS can then access, from the shared memory, the BIOS setting inputs (including those that require reboot) received from display device and formally implement them during the next reboot. In this manner, at least one reboot of the host computing device may be avoided for those BIOS settings that do not require reboot. Moreover, all of the BIOS settings, including those that require reboot, can then be formally implemented by the BIOS from shared memory during a subsequent reboot without the user's awareness or further instruction.

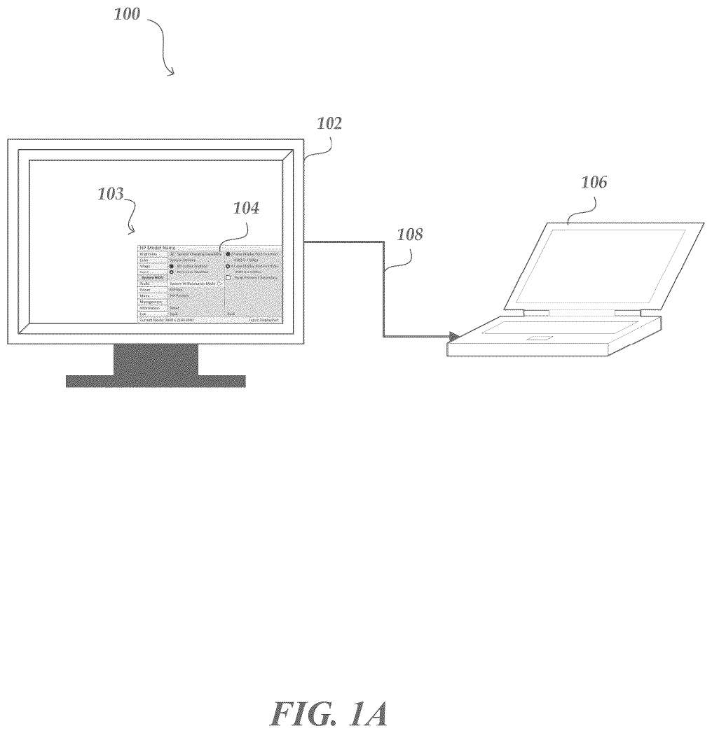

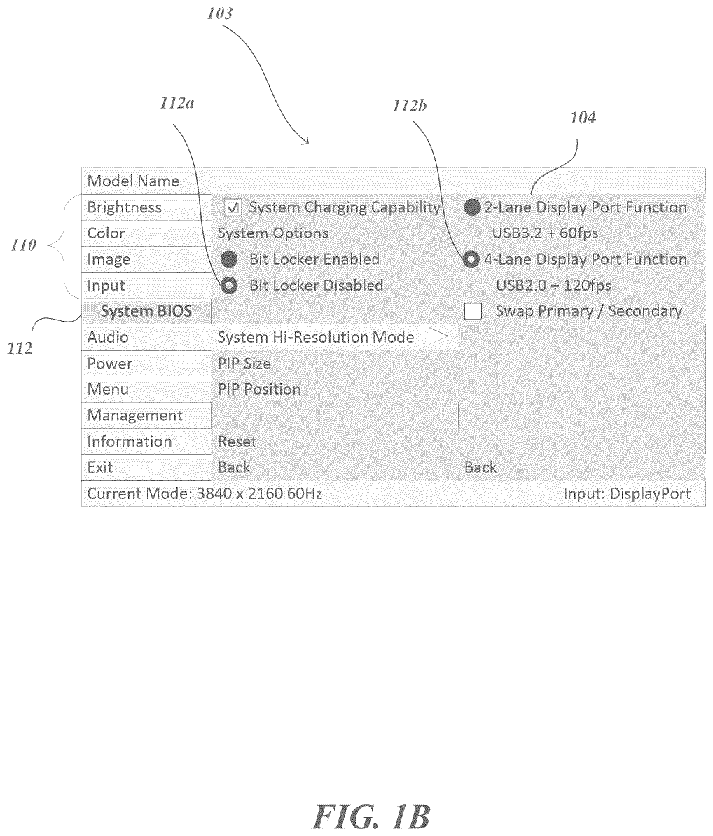

FIG. 1A depicts an example system 100 in which a host computing device 106 is connected to a display device 102 that may be used to affect inputs to settings of the BIOS of the host computing device without requiring an immediate reboot of the host computing device. In the example illustrated in FIG. 1A, the display device 102 may be an external monitor, or a docking monitor in which a docking station is integrated with the external monitor, which is separate from and connected to the host computing device 106 via a connection 108. The connection 108 can be a wired connection made with, e.g., a USB-C cable, an HDMI cable, a DisplayPort cable, a Digital Visual Interface (DVI) cable (or an adapter for any of the foregoing) connected to a corresponding, compatible port of the host computing device, or any other data and/or power transmitting cable or connector. For example, the connection may provide data and power over the same cable (as in the case of USB-C connection) or data only (as in the case of a DVI connection). In other examples, the display device 102 and host computing device 106 are “all-in-one,” and while the functional components of the display device 102 that enable a user to made inputs to a BIOS setting of the host computing device as described herein are separate from the host computing device, the display device 102 communicates with the host computing device via a connection 108 that is internal and made with an embedded connector, e.g., a low-voltage differential signally (LVDS) connector or an embedded DisplayPort (eDP) connector.

In one scenario, a user will operate the system 100 depicted in FIG. 1A by connecting a cable, such as a USB-C cable, to corresponding ports at the host computing device 106 and the display device 102 to establish the connection 108 between the devices. In such a scenario, it will be appreciated that the connection 108 may be considered a physical connection. However, in other examples, the connection 108 may be a logical connection over which data can be exchanged, e.g., between logical network interfaces or devices, or a combination of a logical and physical connection. In response to detecting the connection 108, the host computing device 106 transmits and the display device 102 receives, via the connection 108, the BIOS settings from the host computing device 106 for presentation. Following receipt by the display device 102, the OSD 103 (with which the display device 102 is already equipped) may be presented at the display device 102. The OSD 103 may include a menu 104 of the BIOS settings as they are currently enabled on the host computing device 106. As the OSD 103 including the menu 104 of the host BIOS settings is automatically presented at the display device when the user connects the host computing device 106 to the display device 102, it is not necessary for the user to attempt to activate a BIOS hotkey or switch before the POST is completed or access the BIOS settings through the operating system of the host computing device 106. Instead, the user may make their inputs to the BIOS settings directly via the menu 104 of the display device's OSD 103.

FIG. 1B depicts the example menu 104 shown in FIG. 1A in more detail. The OSD 103 may include OSD settings 110 for adjusting the quality of what is presented on the display device 102, such as screen brightness, color, etc. However, in accordance with the present disclosure, the OSD's menu 104 also includes the BIOS settings 112 retrieved from the host computing device 106. Such settings may include, without limitation, CPU frequency settings, boot order settings, security settings (such as BIOS password and Bit Locker settings), serial advanced technology attachment (SATA) settings for hard drives, optical drives, etc., USB settings, memory timing settings, peripheral settings, hardware interface settings (such as THUNDERBOLT® interface settings), display settings (such as hi-resolution mode settings), power management settings, secure boot settings, fast boot settings, platform settings (such as vPro® settings and platform security configuration settings) and overclocking settings. Those skilled in the art will recognize that the host computing device's BIOS settings may include the same, less than, or more settings depending on the configuration of host computing device 106 and its motherboard without departing from the scope of the present disclosure. The BIOS settings 112 depicted in FIG. 1B for purposes of illustration include BitLocker settings and USB settings.

The menu 104 may include input elements, such as radio buttons, checkboxes, etc., with which the user can select or otherwise input a desired BIOS setting. For example, as illustrated in FIG. 1B, the user may select a radio button 112a labeled “Bit Locker Disabled” in order to input the Bit Locker BIOS setting as “disabled” rather than “enabled.” Similarly, the user can select the radio button 112b labeled “4-Lane Display Port Function USB2.0+120 fps” as opposed to “2-Lane Display Port Function USB3.1+60 pfs.” One skilled in the art will appreciate that the user may select or otherwise input a BIOS setting from the menu 104 by utilizing a user input device, e.g., via a touch display panel of the display device 102 or via a keyboard, mouse, stylus, etc.

As will be described in more detail below, after the input to the BIOS setting is made by the user from the menu 104 of the OSD 103, the display device 102 may transmit the input to the BIOS setting to the host computing device 106 via the connection 108. Once received, the host computing device 106 can store the input to the BIOS setting in memory shared by an EC and the BIOS of the host computing device 106 so that the EC can affect the inputs to certain BIOS setting until the BIOS accesses the inputs from the shared memory and formally implements them during a subsequent, later reboot.

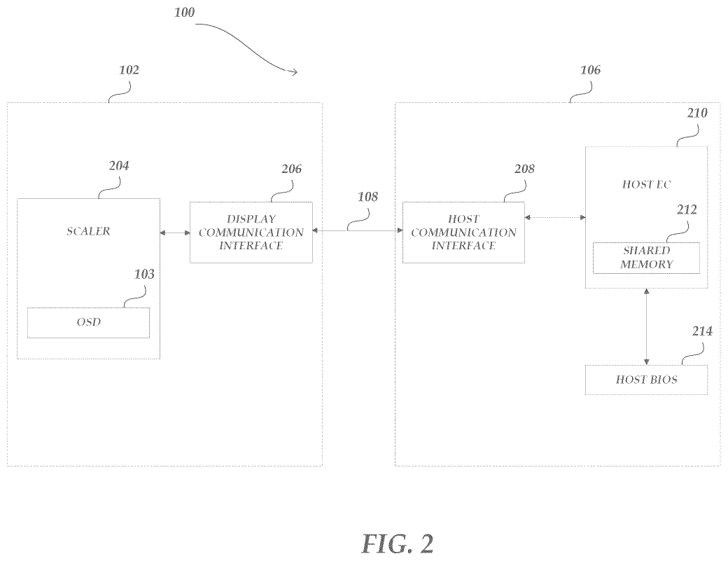

FIG. 2 is a block diagram of example components of the host computing device 106 and the display device 102 that enable inputs to the host computing device's BIOS settings to be affected without requiring immediate reboot of the host computing device 106. As depicted in FIG. 2, the display device 102 may include a scaler 204, and a display communication interface 206. The scaler 204 generates an OSD 103. As noted above, the OSD 103 may include the menu 104 as depicted in FIG. 1B of BIOS settings as they are currently enabled on the host computing device 106. The scaler 204 may receive user input to the BIOS settings via the OSD 103. In accordance with the present disclosure, the scaler 204 may be a chipset that contains a set of integrated circuits executing computer-readable instructions (known a firmware) stored in memory of the chipset, to manage the flow and storage of the data between hardware and/or software components of the display device 102, including between the display communication interface 206 and the OSD 103. The scaler 204 may also be used to process the input to the BIOS setting and instruct the display device communication interface 206 to transmit the BIOS setting input to the host computing device 106. For example, the scaler 204 may compare the BIOS settings presented by the OSD 103 with the BIOS settings previously received from the host computing device 106. If the comparison indicates the BIOS settings received from the OSD 103 are different from the BIOS settings received from the host computing device 106, the scaler may instruct the display communication interface 206 to transmit the BIOS setting input to the host computing device 106. The display communication interface 206 may include hardware and software to enable communication via the connection 108 with the host computing device 106. In some examples, instructing the device display communication interface 206 to transmit the BIOS setting input via the connection 108 includes transmitting the input to the display communication interface 206 in a message format that the display communication interface 206 can translate into a message type that is dependent on the type of connection 108. For example, if the display communication interface 206 includes a USB-C port and the connection 108 is established with a USB-C cable, the BIOS setting input may be translated by the display communication interface 206 into a vendor defined message (VDM) that allows the host computing device 106 and display device 102 to exchange information outside of the USB specification, but in accordance with the USB Power Delivery protocol. As one skilled in the art will recognize, the USB Power Delivery protocol enables a USB-connected device to negotiate power delivery and exchange data over a USB-C cable. The protocol incorporates standard commands as set forth in the USB specification; however, it also enables vendors to add non-standard commands in VDMs. Thus, a VDM can be employed when the connection 108 is a USB-C connection in order to enable transmission of non-standard commands such as BIOS setting inputs.

Returning to the example depicted FIG. 2, a host communication interface 208 of the host computing device 106 may receive the BIOS setting input made at the display device 102 (and in whatever message format into which it may have been translated) via the connection 108. Similar to the display communication interface 206, the host communication interface 208 may include hardware and software to enable communication via the connection 108 with the display device 102. Following receipt, the host communication interface 208, as subordinate to the display device 102, may provide the BIOS setting input with an interrupt to an EC 210 of the host computing device 106. Once received, the EC 210 may store the BIOS setting input in a portion of its memory, identified in FIG. 2 as shared memory 212, which it shares with a BIOS 214 of the host computing device 106. In one example, the memory, including shared memory 212, is a random access memory (RAM); however, those skilled in the art will recognize that other and additional types of volatile memory, such as flash memory, may be used, and that the volatile memory may be static or dynamic.

The host BIOS 214 can be configured as a chipset that contains a set of integrated circuits executing computer-readable instructions (which can be referred to as firmware) stored in memory of the chipset to provide the basic input/output system for the host computing device 106. Accordingly, the host BIOS 214 can configure the host computing device 106 with the BIOS settings stored in the shared memory 212.

Regardless of the type of memory or configuration of the BIOS 214, shared memory 212 may be shared by the EC 210 and BIOS 214 of the host computing device 106 so that each can use the BIOS settings. For example, for those BIOS settings that do not require the host computing device 106 to be rebooted in order to be implemented, EC 210 can implement or otherwise affect an input to a BIOS setting from the shared memory 212 after it is stored and prior to the next reboot of the host computing device 106. In this manner, at least one reboot of the host computing device is avoided as it is not necessary to affect the BIOS setting. Otherwise, if the BIOS setting is of the type that requires a reboot to be implemented, the host BIOS 214 can retrieve the BIOS settings from the shared memory 212 and implement them during the next reboot. Non-limiting examples of BIOS settings that can be implemented without a reboot include certain hardware interface settings (e.g., a THUNDERBOLT setting), display settings (e.g., a hi-resolution mode setting), and power management settings (e.g., charging capability in shutdown state setting). Non-limiting examples of BIOS settings that require a reboot include platform settings such as platform settings (e.g., vPro® settings and platform security configuration settings).

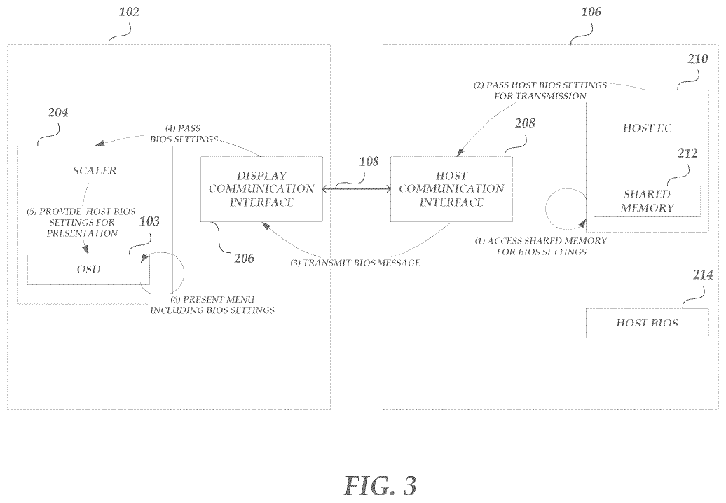

FIG. 3 is a block diagram depicting example interactions between the components of the host computing device 106 and the display device 102 of system 100 when the host computing device 102 communicates the BIOS settings of its BIOS 214 to the display device 102 for presentation by the display device's OSD 103. To display the host BIOS settings, the display device 102 will likely need to have first received the BIOS settings from the host computing device 106. In this regard, at (1), the EC 210 of the host computing device 106, in response to detection of the connection 108 with the display device 102, accesses the shared memory 212 and retrieves the BIOS settings for the host computing device 106. At (2), the host EC 210 passes the BIOS settings to the host communication interface 208 for further transmission. In some examples, the host EC 210 passes the BIOS settings to the host communication interface 208 in accordance with the Inter-Integrated Circuit (I2C) Protocol, which allows multiple peripheral digital integrated circuits chips to communicate with other controller chips.

In some examples, following receipt of the BIOS settings from the host EC 210, the host communication interface 208, may translate the BIOS settings into a VDM depending on the type of connection 108 as described above. Once the BIOS settings are ready for transmission, the host communication interface 208 transmits the BIOS settings (in whatever message format into which it may have been translated) to the display communication interface 206 of the display device 102 at (3). The display communication interface 206 may then translate the BIOS settings into a format usable by the scaler 204 and the OSD 103. At (4), the display communication interface 206 passes the BIOS settings to scaler 204 of the display device 102, which in turn provides the BIOS settings to the OSD 103 for inclusion in the menu 104 at (5). In some examples, the BIOS settings are also provided to the scaler 204 and the OSD 103 in accordance with the I2C Protocol. At (6), the OSD 103 including the menu 104 of the host BIOS settings is presented on the display device 102. It will be appreciated from the foregoing description that, in the described example, the BIOS settings are automatically presented by the OSD 103 in response to the host computing device 106 being connected to the display device 102, rather than in response to a user's selection of a hotkey or other switch of the host computing device 106 during the host boot process.

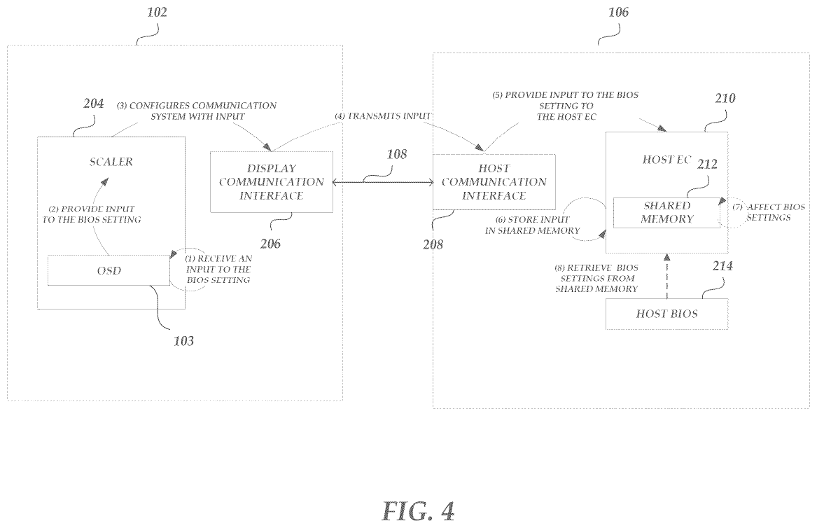

FIG. 4 is a block diagram depicting example interactions between the components of the host computing device 106 and the display device 102 of the system 100 when an input to a BIOS setting is made via the OSD menu 104 once presented as described above in connection with FIGS. 1B and 3. At (1) the OSD 103 receives an input to at least one BIOS setting included in the menu 104. After receiving the input to the BIOS setting, the OSD 103 provides the input to the scaler 204 at (2), e.g., via a bit level shift operation with the scaler 204. In some examples, the OSD 103 may implement a timer to determine when to provide the input to the scaler 204. For example, if the OSD 103 provides a singular input at a time, the OSD 103 may begin a short timer upon user interaction with the OSD 103. To allow the user time to find the desired BIOS setting in the menu 104 and make an input, the timer may define a length of time starting with the presentation of the OSD 103 during which the OSD 103 expects to receive an input. In another example, the OSD 103 may provide for a longer timer to allow for multiple BIOS setting inputs from the menu 104. Accordingly, following expiration of the timer, the OSD 103 automatically input the BIOS setting input(s) to the scaler 204. In other examples, the input to the BIOS settings may be provided to the scaler 204 in response to the OSD 103 receiving an indication from the user to provide the input to the scaler 204. For example, the OSD 103 may have a display element, that when selected, causes the OSD 103 to provide the input to the scaler 204. If the OSD 103 does not detect any interaction with the display element, the OSD 103 may return the BIOS settings in the menu 104 to their original state and/or close or gray-out the menu 104.

Returning to FIG. 4 at (3), the scaler 204 provides the BIOS setting input to the display communication interface 206 (e.g., in accordance with the I2C Protocol) and instructs the display communication interface 206 to transmit the input to the host communication interface 208 of the host computing device 106. As noted above, the display communication interface 206 may translate the BIOS setting input into a message format that is dependent on the type of connection 108. For example, if the connection 108 is established with a USB-C cable, the BIOS setting input may be translated into a VDM for use with such a cable.

At (4), the display communication interface 206 transmits the BIOS setting input to the host communication interface 208 via the connection 108. Following receipt, the host communication interface 208, as subordinate to the display device 102, may provide the BIOS setting input with an interrupt to the host EC 210 of the host computing device 106 at (5). In one example, the host communication interface 208 provides the input in accordance with the I2C Protocol. The host EC 210 stores the BIOS setting input in the shared memory 212 at (6). Accordingly, for immediate implementation for those BIOS settings that can be implemented without a reboot or stored and accessible by the host BIOS 214 when a subsequent reboot occurs for BIOS settings that can only be implemented during a reboot. In some examples, the host computing device 106 may receive multiple inputs to the BIOS settings from the display communication interface 206 of the display device 102. In such cases, the display communication interface 206 may first notify the host communication interface 208 that multiple inputs are forthcoming. Once the BIOS setting inputs have been transmitted, the display communication interface 206 may notify the host communication interface 208 that all of the inputs have been transmitted and/or that the transmission of them is complete. Upon receiving the initial notification, the host communication interface 208 may raise a flag to prevent the host computing device 106 from rebooting before the host communication interface 208 has received all of the BIOS setting inputs from the display communication interface 206. Accordingly, once the host communication interface 208 has received the subsequent notification from the display communication interface 206 that all of the BIOS setting inputs have been transmitted, the host communication interface 208 may lower the flag to indicate that a reboot may proceed.

While the host computing device 106 may reboot immediately after all BIOS setting inputs are stored in the shared memory 212, it is not necessary to do so. Rather, since the BIOS setting inputs are stored in shared memory 212, the EC 210 may affect the BIOS settings that do not require a reboot until a future reboot occurs, e.g., upon the next power up or other restart of the host computing device 106. At that point, the host BIOS 214 may retrieve the BIOS settings including those that require a reboot from shared memory 212 and implement them as shown in FIG. 4 at (7).

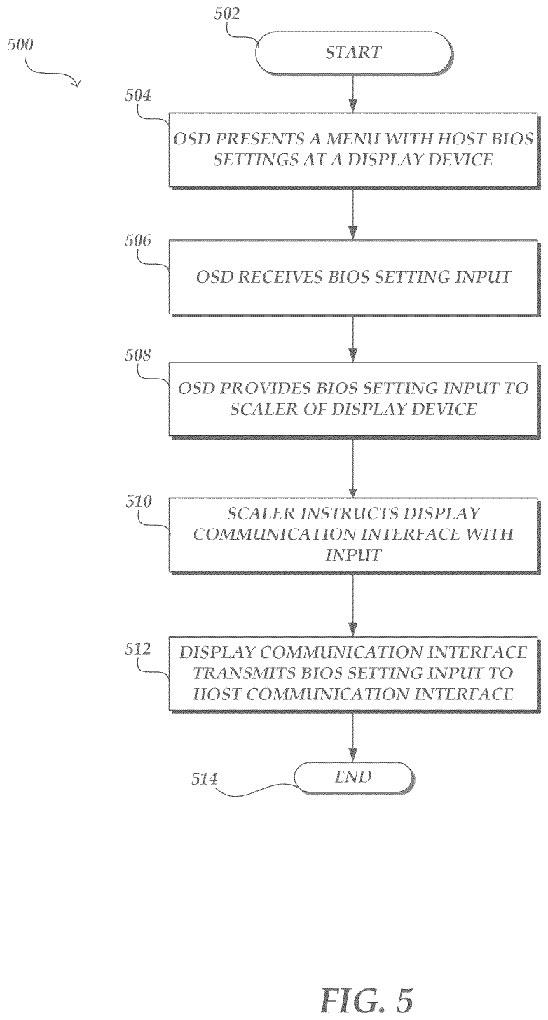

FIG. 5 is a flow diagram depicting an example routine 500 implemented by the display device 102 for providing an input to a BIOS setting made at the display device 102 to the host computing device 106. While routine 500 may be implemented by the display device, it will be appreciated that in other examples the routine may be implemented by a docking station to which the display device 102 connects. The routine 500 starts in block 502 and proceeds to a block 504 where the OSD 103 of the display device 102 is presented at the display device 102. As noted above, the OSD 103 may include a menu 104 of the BIOS settings as they are currently enabled on the host computing device 106. The OSD 103 may be presented in response to receiving the BIOS settings from the host computing device 202, e.g., when a user connects the devices with a cable and a connection 108 between the devices is established. The OSD 103 can be limited to only the menu 104 of BIOS settings of the host commuting device 102 or can also include OSD settings for the display device 102, such as screen brightness.

In some examples, the host BIOS settings may be automatically provided to and presented by the display device's OSD 103 upon detection of the connection 108 between the display device 102 and the host computing device 106. Alternatively, the OSD 103 including the menu 104 of BIOS settings may be presented in response to a request to see the BIOS settings. For example, the user may request presentation of the OSD 103 by pressing a physical button on the display device 102 or selecting a soft key presented on a display panel of the display device, which initiates presentation of the OSD 103. In yet other examples, the OSD 103 may be presented in response to detection of user interaction with the host computing device 106 rather than in response to detection of the connection 108.

Next, in block 506, the OSD 103 of the display device 102 can receive input from the user to a BIOS setting in the menu 104, e.g., via a touch screen of the display device 102, via a keyboard, mouse, stylus, etc. associated with the display device 102 or the host computing device 106, or via physical button or switch on the display device 102. In block 508, the OSD 103 provides the BIOS setting input to the scaler 204 of the display device 102. Upon confirming that the BIOS settings have changed with this input, the scaler 204, at block 510, may provide the input to the BIOS settings and instructions to the display communication interface 206 to transmit the BIOS setting input to the host computing device 106 via the particular connection 108. Thus, in some examples, the display communication interface 206 can translate the BIOS setting input into a message format that is dependent on the type of connection 108, e.g., USB-C, DVI, HDMI, etc. Once the display communication interface 206 has prepared to send the BIOS setting input by translating the BIOS setting input into a message, the display communication interface 206 can transmit the BIOS setting input via connection 108 to the host communication interface 208 of the host computing device 106 at block 512. The routine 500 preformed at the display device 102 then ends at a block 514.

Following transmission of the BIOS setting input to the host computing device 106, the display device 102 may at some point detect that the connection 108 has ceased, e.g., the display communication interface 206 may detect that a USB-C cable has been removed from a corresponding port in the display communication interface 206 or otherwise been disconnected or terminated. Accordingly, the display communication interface 206 may alert the scaler 204 via an interrupt to restore the OSD 103 and menu 104 to a default state in which the standard BIOS settings appear but are not selectable. The scaler 204 will then wait for a next connection 108 to be established, and when it is, routine 500 may be repeated.

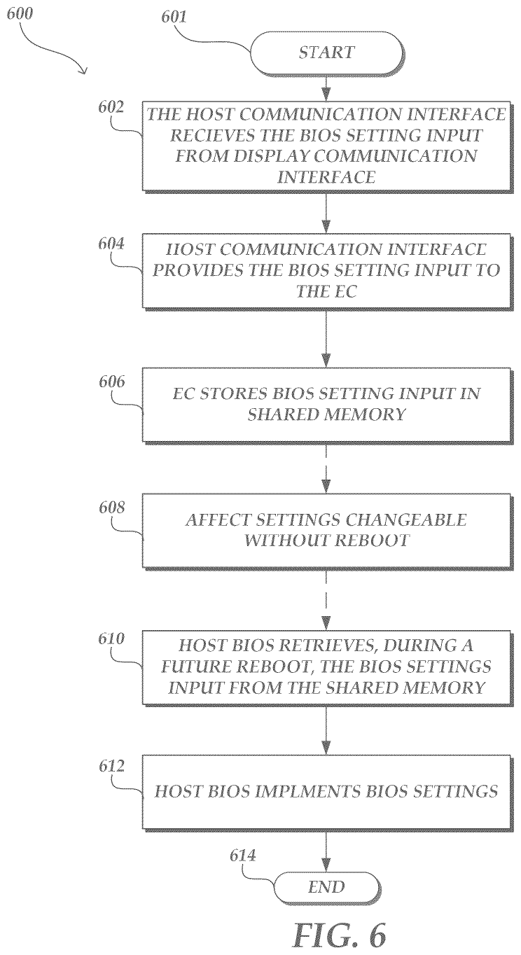

FIG. 6 is a flow diagram depicting an example routine 600 implemented by the host computing device 106 for updating its BIOS 214 with the input to the BIOS setting made at the display device 102. The routine 600 starts at a block 601 and proceeds to a block 602 where the host communication interface 208 receives the BIOS setting input from the display communication interface 206 of the display device 102 via the connection 108. Next, in block 604, the host communication interface 208 provides the BIOS setting input with an interrupt to the host EC 210 to alert the host EC 210 of the incoming BIOS setting input. At block 604, the host communication interface 208 transmits the input to the BIOS setting to the host EC 210.

The EC 210, at block 606, stores the input to the BIOS settings in the shared memory 212 for immediate implementation for BIOS settings that can be affected by an input without rebooting and stored for access by the host computing device 106 during a subsequent reboot for BIOS settings that require a reboot to be affected. Accordingly, the EC 210 may affect the BIOS settings that do not require reboot, including the new BIOS setting input, while waiting for a future reboot of the host computing device 106, e.g., upon the next power up or other restart of the host computing device 106, which avoids an immediate reboot of the host computing device 106. The host BIOS 214 may retrieve the BIOS settings, including the new BIOS setting input, from shared memory 212 during the future reboot as shown in block 608 and implement them as shown in block 610. The routine 600 then ends in a block 612.

It will be appreciated that the host computing device 106, upon reboot and implementation of the BIOS settings retrieved from shared memory 212, may provide the BIOS settings including the new BIOS input back to the display device 102 for presentation, which will ultimately lead to the BIOS settings being received by the display communication interface 206 and passed on to the OSD 103 of the display device 102. In this manner, the system 100 can provide for a reset of the BIOS settings to the original settings, a change to the BIOS settings, or yet other adjustments to the BIOS settings.

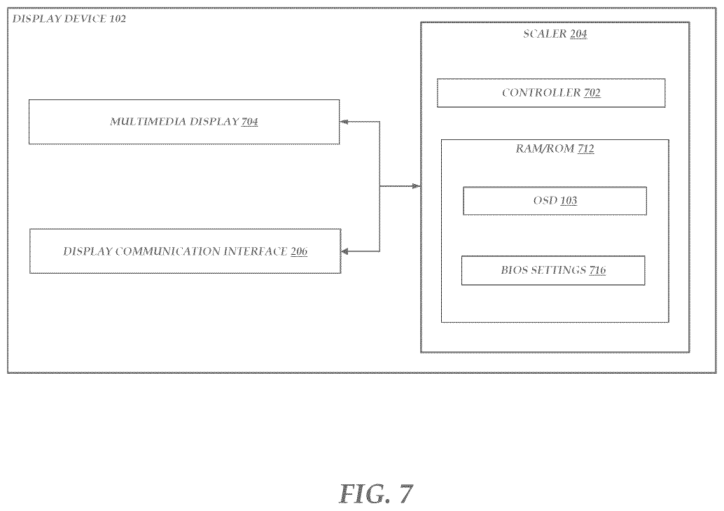

FIG. 7 is a block diagram of an example architecture for a display device 102 that provides, to a host computing device 106, the input to a BIOS setting made at the display device 102. The example architecture of display device 102 depicted in FIG. 7 includes an arrangement of computer hardware and software components that may be used to implement aspects of the present disclosure. In some examples, the display device 102 may include more (or fewer) components than those shown in FIG. 7. As illustrated, the display device 102 includes a multimedia display 704, a display communication interface 206, and a scaler 204, all of which may communicate with one another by way of an internal communication bus. The multimedia display 704 may be any type of display panel suitable for use with a host computing device 106, including without limitation, a light emitting diode (LED) display panel, cathode ray tube (CRT) display panel, liquid crystal display (LCD) panel, thin-film-transistor liquid crystal display (TFT LCD) panel, plasma display panel, or organic light emitting diode (OLED) display panel. In some example the multimedia display 708 may be both an input and output device and the display panel may be a touch panel that accepts touch input. The display communication interface 206 may provide connectivity to other computing devices, such as the host computing device 106 or a docking station to which the host computing device 106 is connected as described in more detail above. The scaler 204 can receive information and instructions from other computing system such as the host computing device 106. Further, the scaler 204 can instruct the display communication interface 206 with inputs to BIOS settings received at the display device 102. The scaler 204 can also provide information to and receive information from the OSD 103.

The scaler 204 may include a controller 702 that executes computer-readable instructions stored in RAM, ROM and/or other persistent or non-transitory memory 712 to implement examples of the present disclosure. For example, in one example, the scaler 204 stores instructions for generating the OSD 103 that includes the menu 104 in which the BIOS settings may be presented to a user of the display device 102. The BIOS settings 716 that are displayed in the menu may also be stored in RAM/ROM memory 712 of the scaler 204.

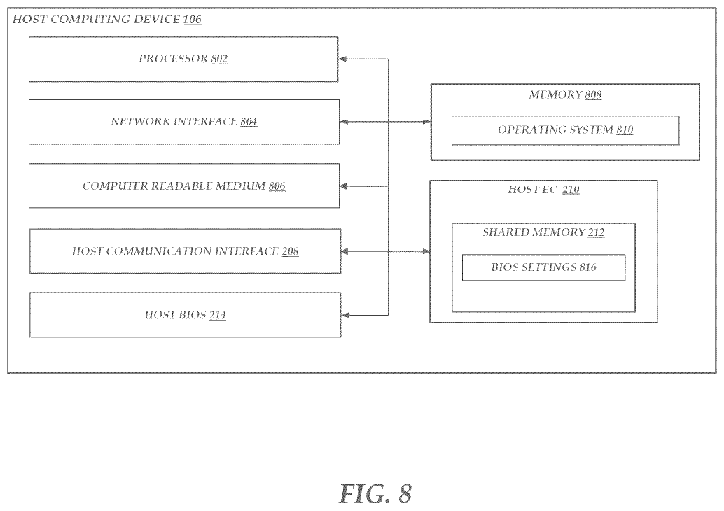

FIG. 8 is a block diagram of an example architecture of a host computing device 106 that updates its BIOS during a future reboot with the input to a BIOS setting made at the display device 102 in accordance with aspects of the present disclosure. The general architecture of host computing device 106 depicted in FIG. 8 includes an arrangement of computer hardware and software components that may be used to implement aspects of the present disclosure. In some examples, the host computing device 106 may include more (or fewer) components than those shown in FIG. 8. As illustrated, the host computing device 106 includes a processor 802, a network interface 804 (e.g., implemented using a network interface card), a computer readable medium 806, a host communication interface 208, a host BIOS 214, and a memory 808, all of which may communicate with one another by way of an internal communication bus. Although not depicted, the host computing device 106 may also include its own multimedia display that may or may not be used in conjunction with the display device 102. The network interface 804 may provide connectivity to networks or computing systems, such as the Internet. The processor 802 may thus receive information and instructions from other computing systems or services via a network. On the other hand, the host communication interface 208 may provide connectivity to external computing devices or peripherals, such as the display device 102 or a docking station to which the display device 102 is also connected as described in more detail above.

The memory 808 may include computer program instructions that the processor 802 executes in order to implement examples in the present disclosure. The memory 808 includes RAM, ROM and/or other persistent or non-transitory memory and may store an operating system 810 that provides computer program instructions for use by the processor 802 in the general administration and operation of the host computing device 106. The memory 808 may further include computer program instructions and other information for implementing aspects of the present disclosure.

Finally, the host computing device 106 may also include an embedded controller, such as EC 210, which assists the processor 802 to perform specific tasks, such as receiving and analyzing signals, and updating the BIOS 214. The EC 210 has its own volatile memory (such as RAM and/or flash memory), independent of memory 808 used by the processor 802, and a portion of its volatile memory, such as shared memory 212, may be shared by the EC 210 and BIOS 214 of the host computing device 106. In accordance with the present disclosure, the EC 210 stores the BIOS settings of the host computing device 106 in shared memory 212. Accordingly, the host BIOS 214 can access the BIOS settings stored within the shared memory 212 during a boot or reboot process of the host computing device 106 to configure the host computing device 106.

It is to be understood that not necessarily all objects or advantages may be achieved in accordance with any particular example described herein. Thus, for example, those skilled in the art will recognize that certain examples may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including specific computer-executable instructions, which are executed by a computing system. The computing system may include at least one computer or processor. The code modules may be stored in any type of non-transitory computer-readable medium or other computer storage device. Some or all the methods may be embodied in specialized computer hardware.

Many other variations than those described herein will be apparent from this disclosure. For example, depending on the example, certain acts, events, or functions of any of the algorithms described herein can be performed in a different sequence, can be added, merged, or left out altogether (e.g., not all described acts or events are necessary for the practice of the algorithms). Moreover, in certain examples, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various example logical blocks, components and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another example, a processor includes an FPGA or other programmable device that performs logic operations without processing computer-executable instructions. A processor can also be implemented as a combination of computing devices, e.g., a combination of a DSP and a microprocessor, a plurality of microprocessors, at least one microprocessor in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain examples include, while other examples do not include, certain features, elements, and/or blocks. Thus, such conditional language is not generally intended to imply that features, elements and/or blocks are in any way required for any examples or that any example necessarily includes logic for deciding, with or without user input or prompting, whether these features, elements, and/or blocks are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A non-transitory computer readable medium comprising computer-executable instructions that, when executed by a controller of a display device, cause the display device to:
in response to detecting a connection with a host device that is separate from the display device, receive basic input/output system (BIOS) setting information from the host device, wherein the BIOS setting information is associated with a BIOS of the host device;
present, via an on-screen display (OSD) of the display device, the BIOS setting information associated with a BIOS of the host device;
receive, via the OSD at the display device, an input to the BIOS setting information associated with the BIOS of the host device; and
transmit the input to the host device via the connection.

2. The non-transitory computer readable medium of claim 1 comprising further computer-executable instructions that, when executed by the controller, cause the display device to translate, based on a type of the connection, the input to the BIOS setting into a format transmittable to the host device.

3. The non-transitory computer readable medium of claim 2, wherein the connection between the host device and the display device is made with at least one of a data and power delivery cable, a data cable, or an embedded connector.

4. The non-transitory computer readable medium of claim 1 further comprising computer-executable instructions that, when executed by the controller, cause the display device to:
initiate a timer upon presenting the BIOS setting information via the OSD, wherein the timer defines a length of time in which the display device expects to receive an input to the BIOS setting via the OSD; and
automatically input the BIOS setting following expiration of the timer.

5. The non-transitory computer readable medium of claim 1 further comprising computer-executable instructions that, when executed by the controller, cause the display device to:
detect that the connection with the host device has ceased; and
restore the BIOS setting information presented in the OSD to a default state.

6. A non-transitory computer readable medium comprising computer-executable instructions that, when executed by a processor of a computing device, cause the computing device to:
in response to detecting a connection with a display device that is separate from the computing device, retrieve a basic input/output system (BIOS) setting associated with a BIOS of the computing device, wherein the connection is between a communication interface of the display device and a communication interface of the computing device;
transmit the BIOS setting to the communication interface of the display device via the connection;
receive at the communication interface of the computing device, via the connection, an input to the BIOS setting from display device; and
update the BIOS of the computing device with the input to the BIOS setting.

7. The non-transitory computer readable medium of claim 6, wherein to update the BIOS of the computing device with the input to the BIOS setting, the non-transitory computer readable medium further comprises computer-executable instructions that, when executed by the processor of the computing device, cause the computing device to:
provide the input to the BIOS setting received at the communication interface of the computing device, to a controller of the computing device, wherein the controller stores the input to the BIOS setting in a shared memory accessible by the controller and the BIOS of the computing device.

8. The non-transitory computer readable medium of claim 7, wherein to update the BIOS of the computing device with the input to the BIOS setting, the non-transitory computer readable medium further comprises computer-executable instructions that, when executed by the processor of the computing device, cause the computing device to:
initiate the BIOS of the computing device on a subsequent reboot of the computing device, wherein the BIOS retrieves the input to the BIOS setting from the shared memory during the subsequent reboot and implements the input to the BIOS setting.

9. The non-transitory computer readable medium of claim 8, wherein the controller of the computing devices affects the input to the BIOS setting stored in the shared memory until the subsequent reboot of the computing device is performed.

10. The non-transitory computer readable medium of claim 8, wherein multiple inputs of BIOS settings are received at the communication interface of the computing device via the connection, and where initiating the subsequent reboot of the computing device is prohibited until all of the multiple inputs are received.

11. The non-transitory computer readable medium of claim 7, wherein the connection between the communication interface of the computing device and the communication interface of the display device is made with at least one of a data and power delivery cable, a data cable, or an embedded connector.

12. The non-transitory computer readable medium of claim 7, wherein a format in which the input to the BIOS setting is received depends on a type of the connection between the communication interface of the computing device and the communication interface of the display device.

13. A display device comprising:
a communication interface;
a display panel; and
a scaler in communication with the display panel and the communication interface, the scaler to:
present, on the display panel, a basic input/output system (BIOS) setting associated with a BIOS of a host device to which the communication interface establishes a connection;
receive an input to the BIOS setting associated with the BIOS of the host device, and
instruct the communication interface to transmit, via the connection to the host device, the input to the BIOS setting.

14. The display device of claim 13, wherein the connection between the host device and the display device is made with at least one of a data and power delivery cable, a data cable, or an embedded connector.

15. The display device of claim 13, wherein the communication interface is to translate, based on a type of the connection, the input to the BIOS setting into a format transmittable by the communication interface via the connection.

16. The display device of claim 15, wherein the communication interface is to transmit the input to the BIOS setting to the host device via the connection after the BIOS setting is translated.

17. The display device of claim 13, wherein the display panel includes an on-screen display (OSD), and wherein the scaler is to present the BIOS setting on the display panel via the OSD.

18. The display device of claim 17, wherein the scaler is to receive the input to the BIOS setting from the OSD.

19. The display device of claim 13, wherein following termination of the connection, the scaler is to present, on the display panel, the BIOS setting in a default state.

20. The display device of claim 13, wherein the scaler is to present, on the display panel, of the BIOS setting after the communication interface establishes the connection with the host device.
